(19) United States
(12) Patent Application Publication
(10) Pub. No.: US 2016/0128050 A1
(43) Pub. Date: May 5, 2016

(54) LICENSED ASSISTED ACCESS NETWORK SYSTEM AND INTERFERENCE AVOIDANCE METHOD THEREOF

(71) Applicant: Institute For Information Industry, Taipei (TW)

(72) Inventors: Shiann-Tsong SHEU, Taipei City (TW); Chiao-Li LIN, Hualien City (TW); Yi-Hsueh TSAI, New Taipei City (TW)

(21) Appl. No.: 14/932,946

(22) Filed: Nov. 4, 2015

Related U.S. Application Data
(60) Provisional application No. 62/075,273, filed on Nov. 5, 2014.

(30) Foreign Application Priority Data
Nov. 2, 2015 (TW) 104136013

(51) Int. Cl. H04W 72/04; H04W 74/04; H04W 28/26; H04W 4/02

(52) U.S. Cl. CPC H04W 72/0406; H04W 4/02; H04W 74/04; H04W 28/26

(57) ABSTRACT

A licensed assisted access network system and an interference avoidance method thereof are provided. The licensed assisted access network system includes a data transmitting network device and a data receiving network device. The data transmitting network device transmits a control message to the data receiving network device in a licensed band. The data receiving network device determines that an unlicensed band is not in use during a receiving end stand-by period according to the control message, and continuously transmits a receiving end channel reservation signal in the unlicensed band. The data transmitting network device receives the receiving end channel reservation signal in the unlicensed band, and transmits network data in the unlicensed band according to the receiving end channel reservation signal. The data receiving network device receives the network data and continuously transmits the receiving end channel reservation signal in the unlicensed band at the same time.

### PRIORITY

This application claims priority benefit of U.S. Provisional Patent Application No. 62/075,273 filed on Nov. 5, 2014 and Taiwan Patent Application No. 104136013 filed on Nov. 2, 2015, which are hereby both incorporated by reference in their entirety.

### FIELD

The present invention relates to a licensed assisted access (LAA) network system and an interference avoidance method thereof. More particularly, the present invention relates to an LAA network system and an interference avoidance method thereof for solving the problem of communication interferences.

### BACKGROUND

In the conventional 3GPP (3^{rd} Generation Partnership Project) networks, the telecommunication operators accomplish data transmissions mainly through respective licensed bands. However, the efficiency of this data transmission mechanism is limited by the bandwidths of the licensed bands. Accordingly, the licensed assisted access (LAA) technology has been developed.

Specifically, the main idea of the LAA technology is to transmit control messages in the licensed channels and use unlicensed channels to assist in transmission of the network data. In this way, the efficiency of network data transmission can be effectively improved by use of the unlicensed channels.

However, there is no limitation on use of the unlicensed channels. Therefore, when different base stations use a same unlicensed channel for data transmission in a same communication coverage without having a coordination mechanism therebetween, communication interferences would occur therebetween to seriously affect the network transmission efficiency.

Accordingly, an urgent need exists in the art to make an improvement on the aforesaid shortcoming of the conventional LAA technology through coordination between operations of different base stations in the unlicensed channels to mitigate the communication interferences.

### SUMMARY

The disclosure includes an interference avoidance method for a licensed assisted access (LAA) network system. The LAA network system comprises a data transmitting network device and a data receiving network device. The interference avoidance method comprises the following steps of: (a) enabling the data transmitting network device to transmit a control message to the data receiving network device in a licensed channel; (b) enabling the data receiving network device to determine that an unlicensed channel is not in use during a receiving end stand-by period according to the control message; (c) enabling the data receiving network apparatus to continuously send a receiving end channel reservation signal in the unlicensed channel according to the determination result of the step (b); (d) enabling the data transmitting network device to receive the receiving end channel reservation signal in the unlicensed channel; (e) enabling the data transmitting network device to transmit network data in the unlicensed channel according to the receiving end channel reservation signal; and (f) enabling the data receiving network device to receive the network data in the unlicensed channel simultaneously when continuously sending the receiving end channel reservation signal.

Disclosed is a licensed assisted access (LAA) network system, comprising a data transmitting network device and a data receiving network device. The data transmitting network device transmits a control message to the data receiving network device in a licensed channel. The data receiving network device determines that an unlicensed channel is not in use during a receiving end stand-by period according to the control message, and continuously sends a receiving end channel reservation signal in the unlicensed channel. The data transmitting network device receives the receiving end channel reservation signal in the unlicensed channel, and transmits network data in the unlicensed channel according to the receiving end channel reservation signal. The data receiving network device receives the network data in the unlicensed channel simultaneously when continuously sending the receiving end channel reservation signal.

Also disclosed is a licensed assisted access (LAA) network system. The LAA network system comprises a first base station and a second base station. The first base station belongs to a first base station group, and the second base station belongs to a second base station group. The interference avoidance method comprises the following steps of: (a) enabling the first base station to scan an unlicensed band, wherein the unlicensed band comprises a first unlicensed channel and a second unlicensed channel; (b) enabling the first base station to receive a first message of a third base station in the first unlicensed channel after the step (a), wherein the third base station belongs to the first base station; (c) enabling the first base station to send a second message in the first unlicensed channel according to the first message; (d) enabling the second base station to scan the unlicensed band after the step (c); (e) enabling the second base station to receive the second message in the first unlicensed channel; and (f) enabling the second base station to choose the second unlicensed channel for data transmission with a mobile station according to the second message.

The disclosure further includes a licensed assisted access (LAA) network system, which comprises a first base station belonging to a first base station group and a second base station belonging to a second base station group. The first base station scans an unlicensed band comprising a first unlicensed channel and a second unlicensed channel. The first base station receives a first message of a third base station in the first unlicensed channel, and the third base station belongs to the first base station. The first base station sends a second message in the first unlicensed channel according to the first message. The second base station scans the unlicensed band and receives the second message in the first unlicensed channel. The second base station chooses the second unlicensed channel for data transmission with a mobile station according to the second message.

The disclosure includes an interference avoidance method for a first base station. The first base station is used in a licensed assisted access (LAA) network system. The interference avoidance method comprising the following steps of: (a) enabling the first base station to retrieve a piece of base station information from a base station status database, wherein the base station information records a piece of location information and a piece of channel usage information of a second base station, and the channel usage information records that a first unlicensed channel is used by the second base station for data transmission; and (b) enabling the first base station to choose a second unlicensed channel for data transmission with a mobile station according to the base station information.

The disclosure also includes a first base station for a licensed assisted access (LAA) network system. The base station comprises a processor and a transceiver. The transceiver retrieves a piece of base station information from a base station status database, wherein the base station information records a piece of location information and a piece of channel usage information of a second base station, and the channel usage information records that a first unlicensed channel is used by the second base station for data transmission. The processor chooses a second unlicensed channel according to the base station information and transmits data with a mobile station via the transceiver.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an LAA network system according to a first embodiment of the present invention;

FIG. 1B is a block diagram of a data transmitting network device in the first embodiment of the present invention;

FIG. 1C is a block diagram of a data receiving network device in the first embodiment of the present invention;

FIG. 1D is a schematic view illustrating channel usage in the LAA network system according to the first embodiment of the present invention;

FIG. 2A is a schematic view of an LAA network system according to a second embodiment of the present invention;

FIG. 2B is a schematic view illustrating channel usage in the LAA network system according to the second embodiment of the present invention;

FIG. 3A is a schematic view of an LAA network system according to a third embodiment of the present invention;

FIG. 3B is a schematic view illustrating channel usage in the LAA network system according to the third embodiment of the present invention;

FIG. 4A is a schematic view of an LAA network system according to a fourth embodiment of the present invention;

FIG. 4B is a schematic view illustrating channel usage in the LAA network system according to the fourth embodiment of the present invention;

FIGS. 5A˜5C are schematic views of an LAA network system according to a fifth embodiment of the present invention;

FIGS. 6A˜6C are schematic views of an LAA network system according to a sixth embodiment of the present invention;

FIG. 7 is a flowchart diagram of an interference avoidance method according to a seventh embodiment of the present invention;

FIG. 8 is a flowchart diagram of an interference avoidance method according to an eighth embodiment of the present invention;

FIG. 9 is a flowchart diagram of an interference avoidance method according to a ninth embodiment of the present invention;

FIGS. 10A˜10B are flowchart diagrams of an interference avoidance method according to a tenth embodiment of the present invention; and

FIGS. 11A˜11B are flowchart diagrams of an interference avoidance method according to an eleventh embodiment of the present invention.

### DETAILED DESCRIPTION

In the following description, the present invention will be explained with reference to certain example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention. In the following example embodiments and the attached drawings, elements unrelated to the present invention are omitted from depiction; and dimensional relationships among individual elements in the attached drawings are illustrated only for ease of understanding, but not to limit the actual scale.

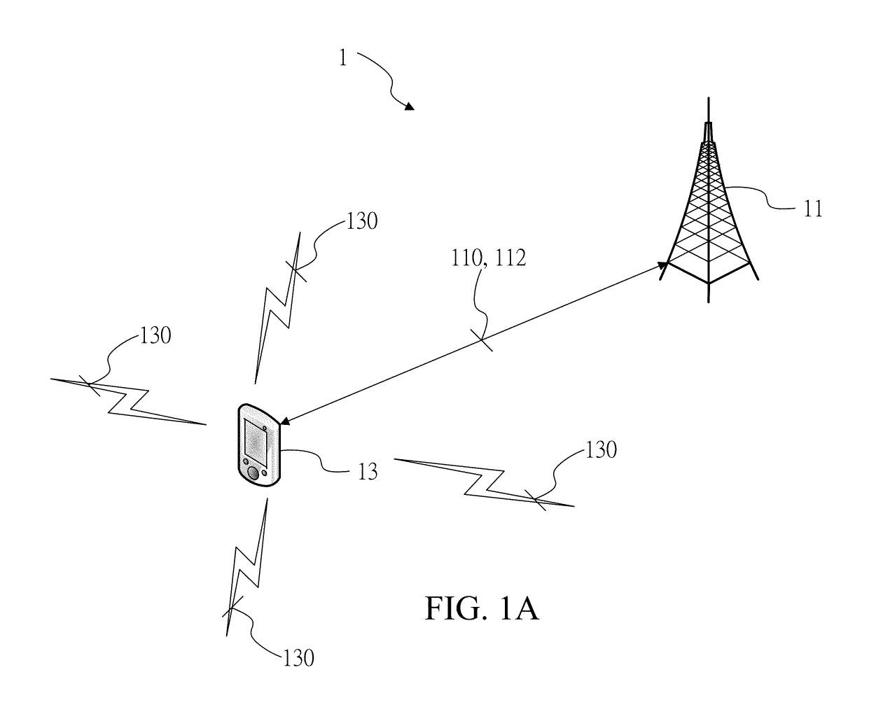

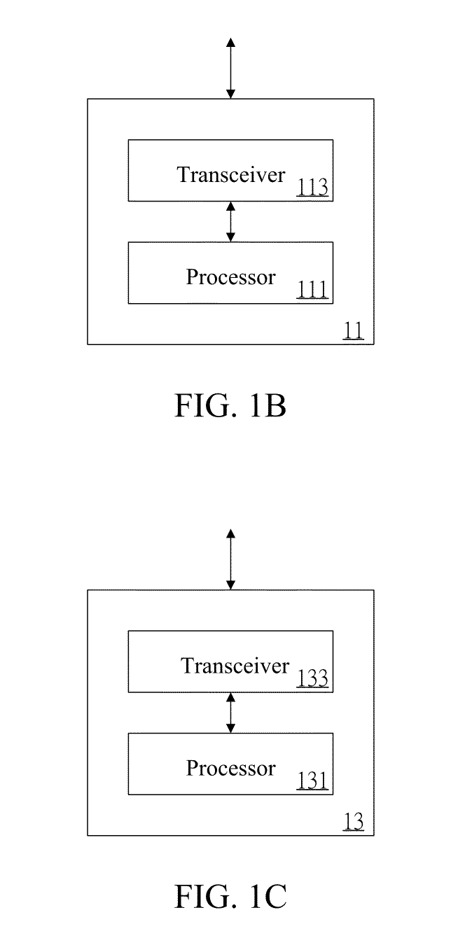

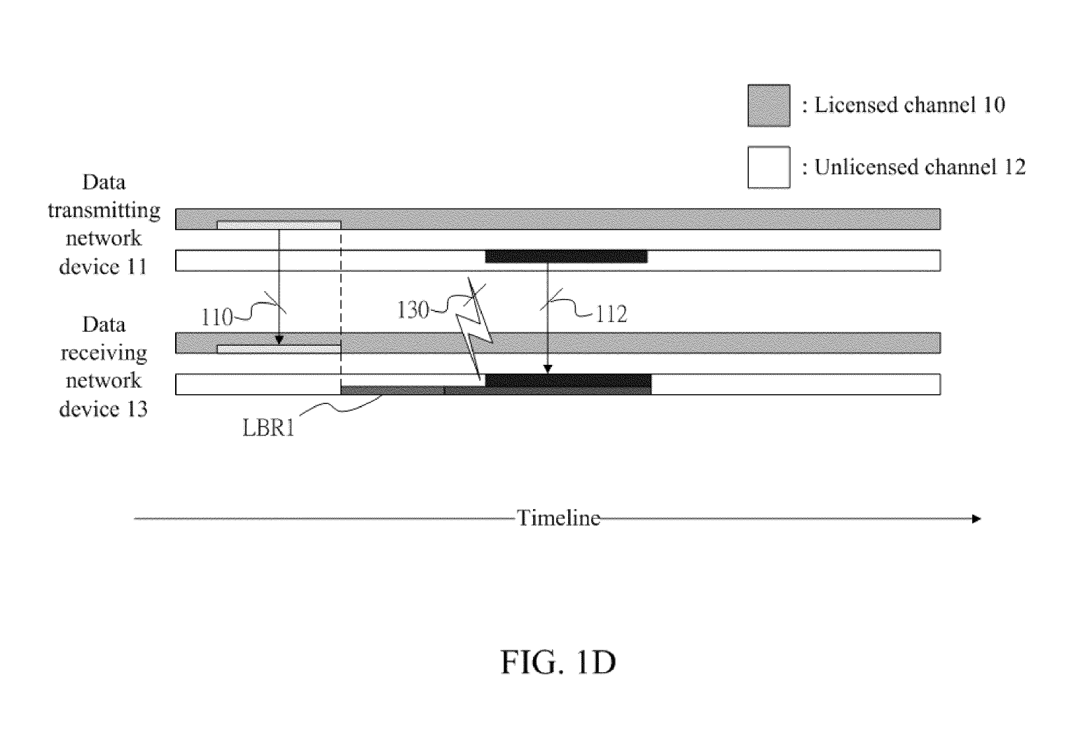

Please refer to FIGS. 1A˜1C. FIG. 1A is a schematic view of an LAA network system 1 according to a first embodiment of the present invention. The LAA network system 1 comprises a data transmitting network device 11 and a data receiving network device 13. FIG. 1B is a block diagram of the data transmitting network device 11 in the first embodiment of the present invention. The data transmitting network device 11 comprises a processor 111 and a transceiver 113. FIG. 1C is a block diagram of the data receiving network device 13 in the first embodiment of the present invention. The data receiving network device 13 comprises a processor 131 and a transceiver 133.

It shall be particularly noted that, in the first embodiment, the data transmitting network device 11 is a base station, the data receiving network device 13 is a mobile station, and the data transmitting network device 11 and the data receiving network device 13 communicate mainly through a licensed channel 10. However, the roles of the data transmitting network device 11 and the data receiving network device 13 may be swapped with each other, and what described herein is not intended to limit hardware implementations thereof. Interactions of the LAA network system 1 and the devices thereof will be further described hereinbelow.

Please refer to FIG. 1D together, which is a schematic view illustrating channel usage in the LAA network system 1 according to the first embodiment of the present invention. Firstly, the transceiver 113 of the data transmitting network device 11 transmits a control message 110 to the data receiving network device 13 in the licensed channel 10 to notify the data receiving network device 13 of information related to subsequent data transmissions. The control message 110 comprises notification information notifying the data receiving network device 13 that data is to be transmitted in an unlicensed channel 12.

Next, after the control message 110 is received by the transceiver 133 of the data receiving network device 13, the processor 131 determines that the unlicensed channel is not in use during a receiving end stand-by period LBR1 according to the control message 10. Once it has been determined via the transceiver 133 that the unlicensed channel 12 is not in use, the processor 131 of the data receiving network device 13 may continuously send a receiving end channel reservation signal 130 in the unlicensed channel 12 via the transceiver 133 to notify related nearby network devices that the unlicensed channel 12 is being occupied, thus avoiding use of the unlicensed channel 12 by other network devices.

Then, after the receiving end channel reservation signal 130 is received by the transceiver 113 of the data transmitting network device 11, the processor 111 may transmit network data 112 in the unlicensed channel 12 via the transceiver 113 and according to the receiving end channel reservation signal 130. The transceiver 133 of the data receiving network device 13 may receive the network data 112 in the unlicensed channel 12 simultaneously when continuously sending the receiving end channel reservation signal 130.

In other words, the data receiving network device 13 continuously sending the receiving end channel reservation signal 130 means that it can continuously notify the related nearby network devices that the unlicensed channel 12 is being occupied. On the other hand, the data receiving network device 13 may receive the network data 112 in the unlicensed channel at the same time. In this way, the unlicensed channel 12 can be efficiently used by the data receiving network device 13 to receive the network data 112 without occurrence of interferences.

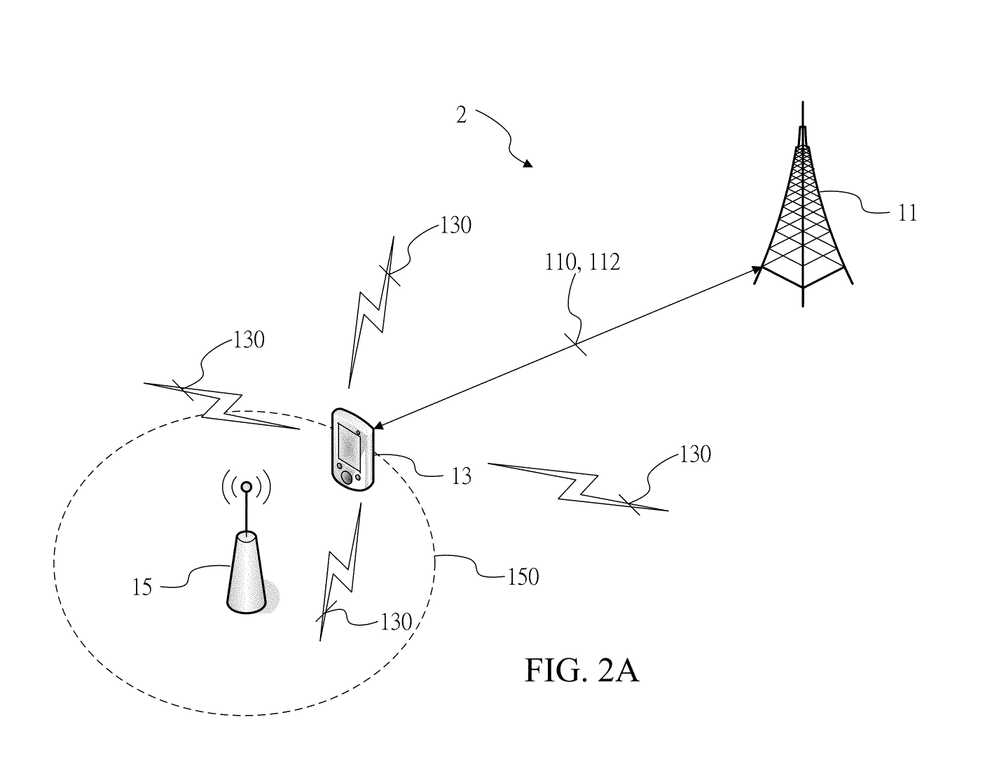

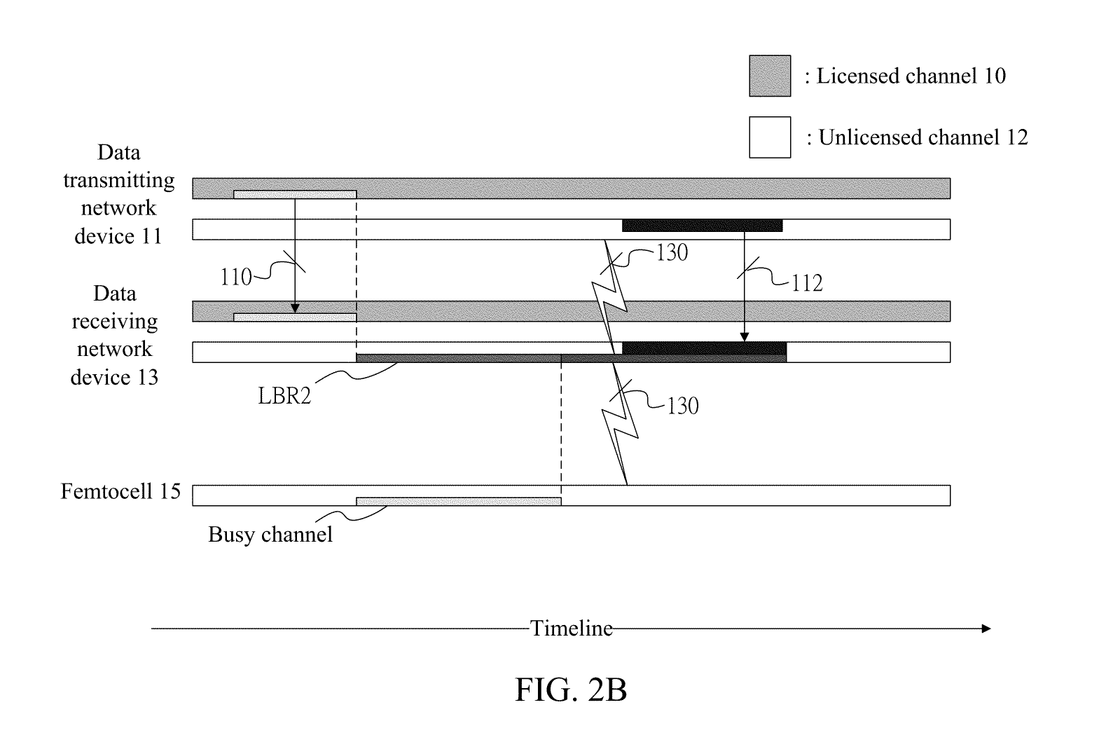

Please refer to FIGS. 2A˜2B. FIG. 2A is a schematic view of an LAA network system 2 according to a second embodiment of the present invention, and FIG. 2B is a schematic view illustrating channel usage in the LAA network system 2 according to the second embodiment of the present invention. The data receiving network device 13 is located within a coverage 150 of a femtocell 15 that uses the unlicensed channel 12 to transmit data. The framework of the second embodiment is similar to that of the first embodiment, so elements bearing the same symbols also have the same functions and will not be described again herein. The second embodiment will mainly describe the interference avoidance technology in more detail.

Similarly, the transceiver 113 of the data transmitting network device 11 transmits the control message 110 to the data receiving network device 13 in the licensed channel 10 to notify the data receiving network device 13 of information related to subsequent data transmission. The control message 110 comprises notification information notifying the data receiving network device 13 that data is to be transmitted in the unlicensed channel 12.

Next, after the control message 110 is received by the transceiver 133 of the data receiving network device 13, the processor 131 determines whether the unlicensed channel 12 is not in use during a receiving end stand-by period LBR2 according to the control message 110. In the second embodiment, the unlicensed channel 12 is being occupied by the femtocell 15 (shown to be busy in the figure), so the data receiving network device 13 has to wait for release of the unlicensed channel 12.

Then, when the processor 131 of the data receiving network device 13 determines via the transceiver 133 that the unlicensed channel 12 has become free (i.e., determines that the unlicensed channel 12 is no longer occupied by the femtocell 15) during the receiving end stand-by period LBR1, the processor 131 continuously sends the receiving end channel reservation signal 130 in the unlicensed channel 12 via the transceiver 133 to notify the related nearby network device (i.e., the femtocell 15) that the unlicensed channel 12 is being occupied, thus avoiding use of the unlicensed channel 12 by the related nearby network device (i.e., the femtocell 15).

After the receiving end channel reservation signal 130 has been received by the transceiver 113 of the data receiving network device 13, the processor 111 may transmit the network data 112 in the unlicensed channel 12 via the transceiver 113 and according to the receiving end reservation signal 130. The transceiver 133 of the data receiving network device 13 may receive the network data 112 in the unlicensed channel 12 simultaneously when continuously sending the receiving end reservation signal 130.

Similarly, the data receiving network device 13 continuously sending the receiving end channel reservation signal 130 means that it can continuously notify the related nearby network device (the femtocell 15) that the unlicensed channel 12 is being occupied. On the other hand, the data receiving network device 13 may receive the network data 112 in the unlicensed channel at the same time. In this way, the unlicensed channel 12 can be efficiently used by the data receiving network device 13 to receive the network data 112 without occurrence of interferences.

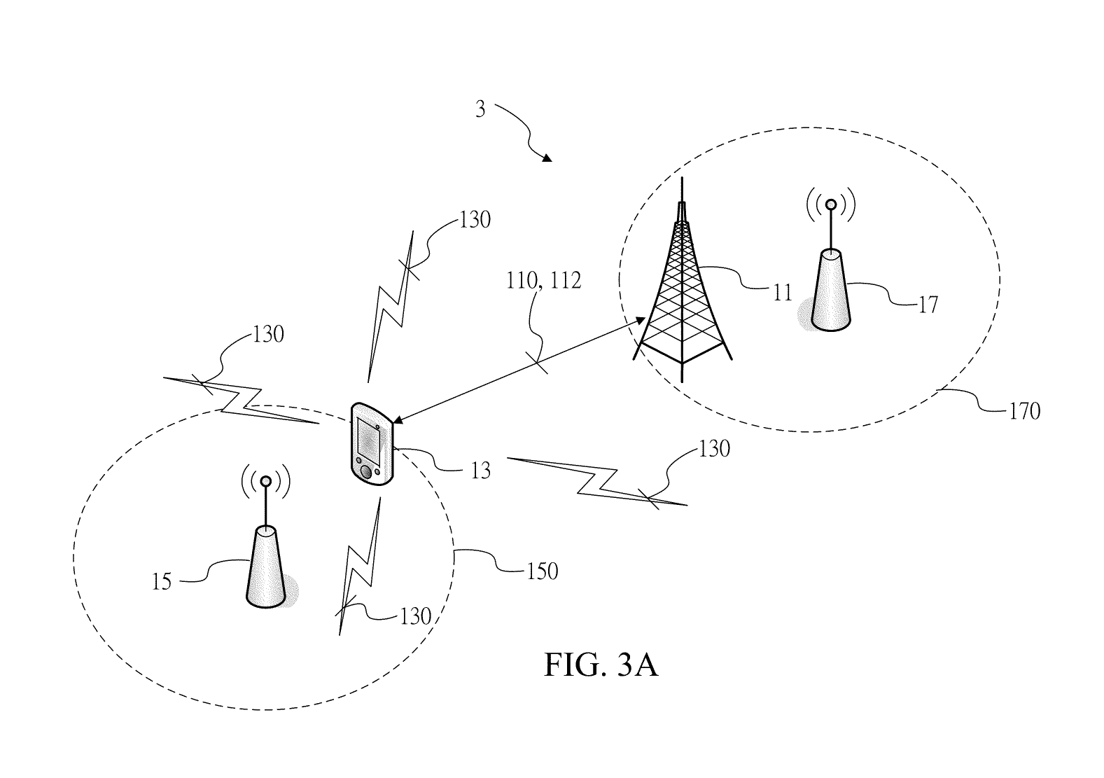

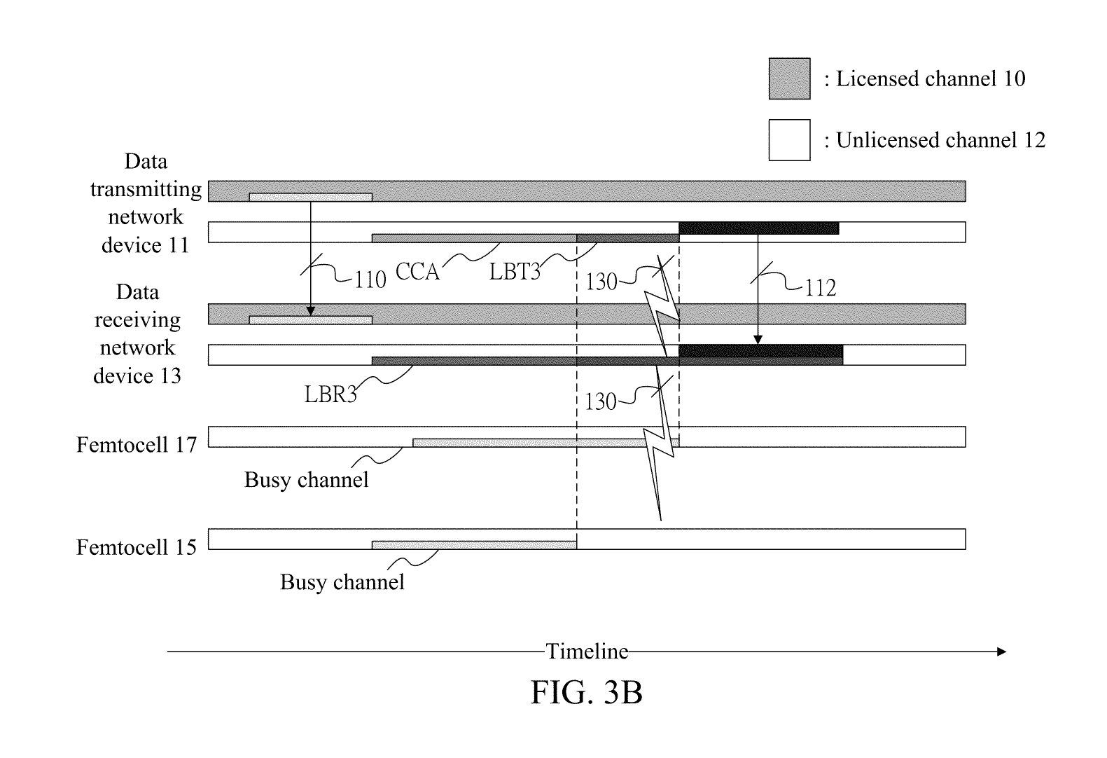

Please refer to FIGS. 3A˜3B. FIG. 3A is a schematic view of an LAA network system 3 according to a third embodiment of the present invention, and FIG. 3B is a schematic view illustrating channel usage in the LAA network system 3 according to the third embodiment of the present invention. The data transmitting network device 11 is located within a coverage 170 of a femtocell 17 that uses the unlicensed channel 12 to transmit data. The framework of the third embodiment is similar to those of the previous embodiments, so elements bearing the same symbols also have the same functions and will not be described again herein. The third embodiment will mainly describe the interference avoidance technology in more detail.

Similarly, the transceiver 113 of the data transmitting network device 11 transmits the control message 110 to the data receiving network device 13 in the licensed channel 10 to notify the data receiving network device 13 of information related to subsequent data transmissions. The control message 110 comprises notification information notifying the data receiving network device 13 that data is to be transmitted in the unlicensed channel 12. Then, the data transmitting network device 11 enters into a Clear Channel Assessment interval CCA to wait for a response from the data receiving network device 13.

Next, after the control message 110 is received by the transceiver 133 of the data receiving network device 13, the processor 131 determines whether the unlicensed channel 12 is not in use during a receiving end stand-by period LBR1 according to the control message 110. In the third embodiment, the unlicensed channel 12 is being occupied by the femtocell 15 (shown to be busy in the figure), so the data receiving network device 13 has to wait for release of the unlicensed channel 12.

Then, when the processor 131 of the data receiving network device 13 determines via the transceiver 133 that the unlicensed channel 12 has become free (i.e., determines that the unlicensed channel 12 is no longer occupied by the femtocell 15) during the receiving end stand-by period LBR1, the processor 131 continuously sends the receiving end channel reservation signal 130 in the unlicensed channel 12 via the transceiver 133 to notify the related nearby network device (i.e., the femtocell 15) that the unlicensed channel 12 is being occupied, thus avoiding use of the unlicensed channel 12 by the nearby network device (i.e., the femtocell 15).

After the receiving end channel reservation signal 130 has been received by the transceiver 113 of the data receiving network device 13, the processor 111 firstly determines whether the unlicensed channel 12 is not in use during a transmitting end stand-by period LBT3 according to the receiving end channel reservation signal 130. In the third embodiment, the unlicensed channel 12 is being occupied by the femtocell 17 (shown to be busy in the figure), so the data transmitting network device 11 has to wait for release of the unlicensed channel 12.

Thereafter, when the processor 111 of the data transmitting network device 11 determines via the transceiver 113 that the unlicensed channel 12 has become free (i.e., determines that the unlicensed channel 12 is no longer occupied by the femtocell 17) during the transmitting end stand-by period LBT3, the processor 111 transmits the network data 112 in the unlicensed channel 12 via the transceiver 113. Then, the transceiver 133 of the data receiving network device 13 may receive the network data 112 in the unlicensed channel 12 simultaneously when continuously sending the receiving end channel reservation signal 130 in the unlicensed channel 12.

Similarly, the data transmitting network device 11 continuously sending the network data 112 means that it can continuously notify the related nearby network device (the femtocell 17) that the unlicensed channel 12 is being occupied, and the data receiving network device 13 continuously sending the receiving end channel reservation signal 130 means that it can continuously notify the related nearby network device (the femtocell 15) that the unlicensed channel 12 is being occupied. On the other hand, the data receiving network device 13 may receive the network data 112 in the unlicensed channel at the same time. In this way, the unlicensed channel 12 can be efficiently used by the data receiving network device 13 to receive the network data 112 without occurrence of interferences.

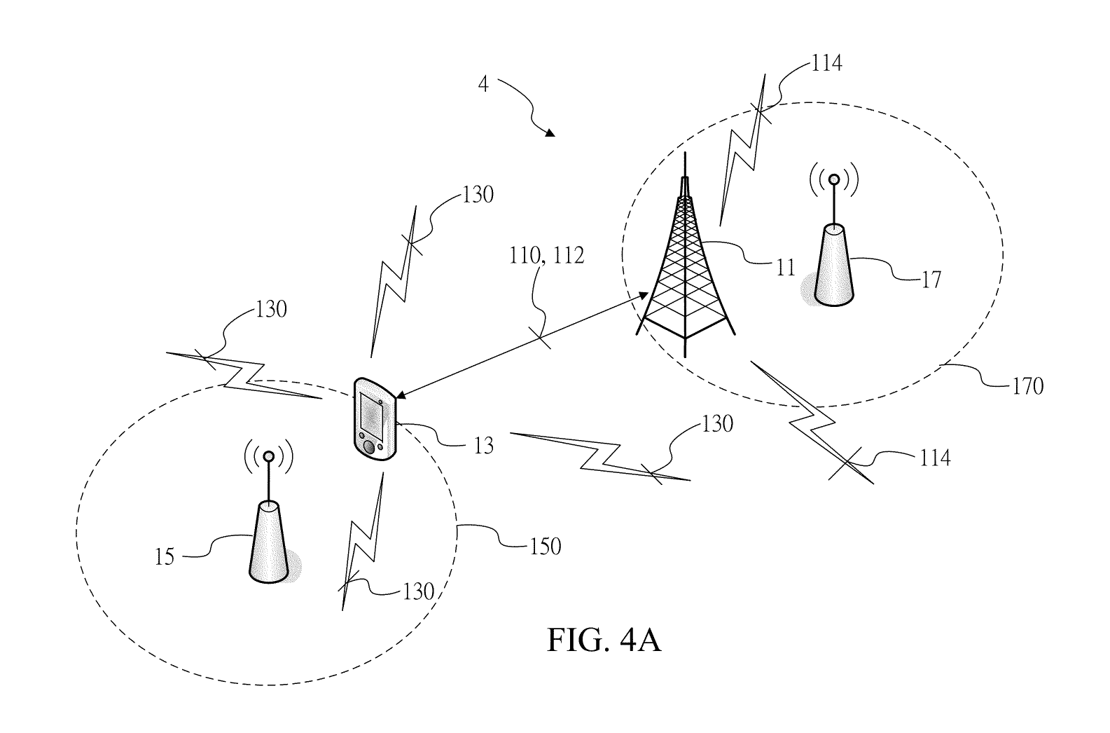

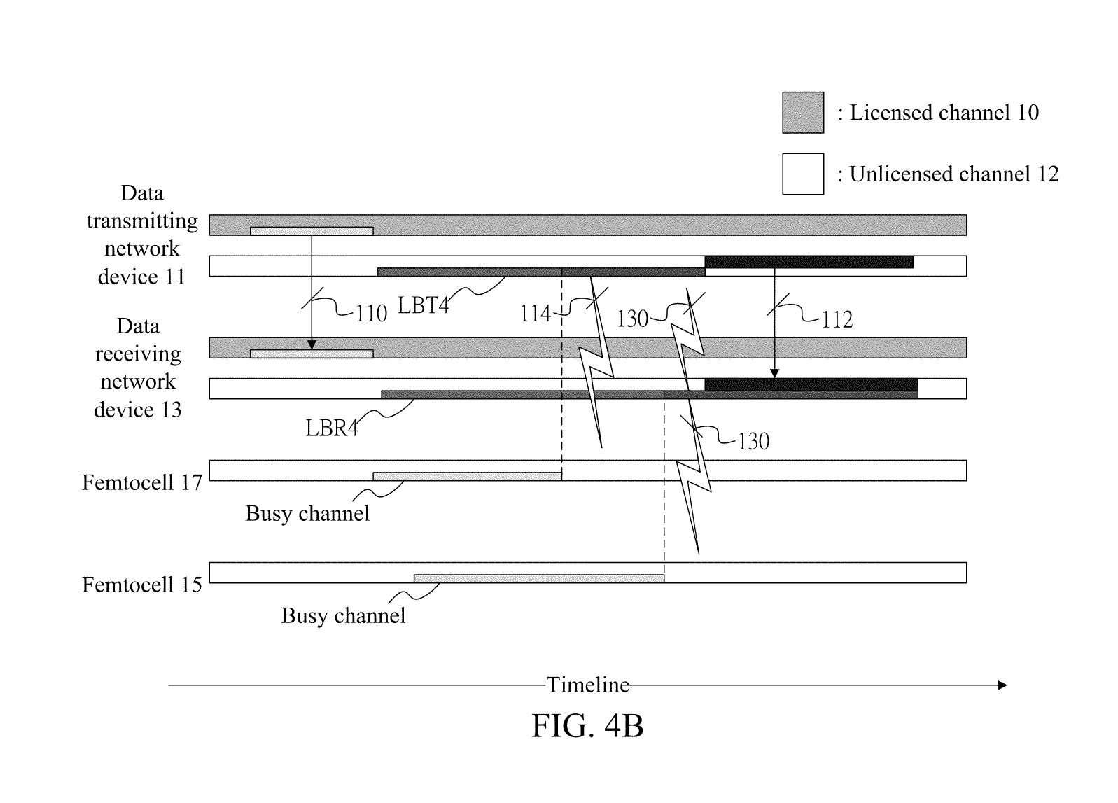

Please refer to FIGS. 4A˜4B. FIG. 4A is a schematic view of an LAA network system 4 according to a fourth embodiment of the present invention, and FIG. 4B is a schematic view illustrating channel usage in the LAA network system 4 according to the fourth embodiment of the present invention. The framework of the fourth embodiment is similar to those of the previous embodiments, so elements bearing the same symbols also have the same functions and will not be described again herein. The fourth embodiment will mainly describe the interference avoidance technology in more detail.

Similarly, the transceiver 113 of the data transmitting network device 11 transmits the control message 110 to the data receiving network device 13 in the licensed channel 10 to notify the data receiving network device 13 of information related to subsequent data transmissions. The control message 110 comprises notification information notifying the data receiving network device 13 that data is to be transmitted in the unlicensed channel 12.

Next, the processor 111 of the data transmitting network device 11 determines whether the unlicensed channel 12 is not in use during a transmitting end stand-by period LBT4. In the fourth embodiment, the unlicensed channel 12 is being occupied by the femtocell 17 (shown to be busy in the figure), so the data transmitting network device 11 has to wait for release of the unlicensed channel 12.

Then, when the processor 111 of the data transmitting network device 11 determines via the transceiver 113 that the unlicensed channel 12 has become free (i.e., determines that the unlicensed channel 12 is no longer occupied by the femtocell 17) during the transmitting end stand-by period LBT4, the processor 111 continuously sends a transmitting end channel reservation signal 114 in the unlicensed channel 12 via the transceiver 113 to notify the related nearby network device (i.e., the femtocell 17) that the unlicensed channel 12 is being occupied, thus avoiding use of the unlicensed channel 12 by the related nearby network device (i.e., the femtocell 17).

On the other hand, after the control message 110 has been received by the transceiver 13 of the data receiving network device 13, the processor 131 determines whether the unlicensed channel 12 is not in use during a receiving end stand-by period LBR4 according to the control message 110. In the fourth embodiment, the unlicensed channel 12 is being occupied by the femtocell 15 (shown to be busy in the figure), so the data receiving network device 13 has to wait for release of the unlicensed channel 12.

Thereafter, when the processor 131 of the data receiving network device 13 determines via the transceiver 133 that the unlicensed channel 12 has become free (i.e., determines that the unlicensed channel 12 is no longer occupied by the femtocell 15) during the receiving end stand-by period LBR4, the processor 131 continuously sends the receiving end channel reservation signal 130 in the unlicensed channel 12 via the transceiver 133 to notify the related nearby network device (i.e., the femtocell 15) that the unlicensed channel 12 is being occupied, thus avoiding use of the unlicensed channel 12 by the nearby network device (i.e., the femtocell 15).

After the receiving end channel reservation signal 130 is received by the transceiver 113 of the data transmitting network device 11, the processor 111 can stop sending the transmitting end channel reservation signal 114 according to the receiving end channel reservation signal 130 and transmit the network data 112 in the unlicensed channel 12 via the transceiver 113. The transceiver 133 of the data receiving network device 13 may receive the network data 112 in the unlicensed channel 12 simultaneously when continuously sending the receiving end channel reservation signal 130.

Similarly, the data transmitting network device 11 continuously sending the network data 112 means that it can continuously notify the related nearby network device (the femtocell 17) that the unlicensed channel 12 is being occupied, and the data receiving network device 13 continuously sending the receiving end channel reservation signal 130 means that it can continuously notify the related nearby network device (the femtocell 15) that the unlicensed channel 12 is being occupied. On the other hand, the data receiving network device 13 may receive the network data 112 in the unlicensed channel at the same time. In this way, the unlicensed channel 12 can be efficiently used by the data receiving network device 13 to receive the network data 112 without occurrence of interferences.

It shall be emphasized again that, in the previous embodiments, the data transmitting network device 11 is a base station and the data receiving network device 13 is a mobile station, and mainly the interference avoidance in the downlink data transmissions has been described. However, those skilled in the art can readily understand from the above descriptions that the roles of the data transmitting network device 11 and the data receiving network device 13 can be swapped with each other (i.e., the data transmitting network device 11 is a mobile station and the data receiving network device 13 a base station) and can understand the interference avoidance in the uplink data transmissions, so these will not be further described herein.

It shall be additionally noted that, in the previous embodiments, both the data transmitting network device 11 and the data receiving network device 13 have the functions of transmitting data and receiving data simultaneously, which may be accomplished mainly by the Full-Duplex Radio (FRD) technology. However, those skilled in the art can readily understand from the above disclosures that the technology of the present invention is accomplished on the basis of transmitting data and receiving data simultaneously, but does not limit the way of transmitting data and receiving data simultaneously.

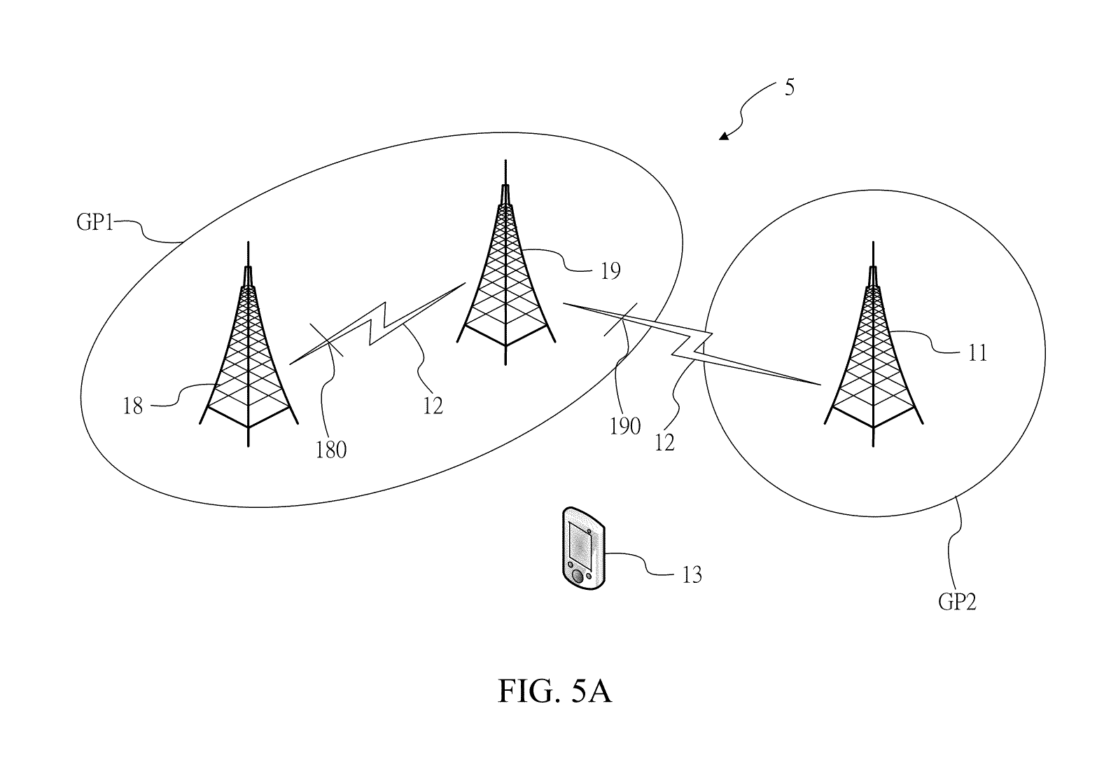

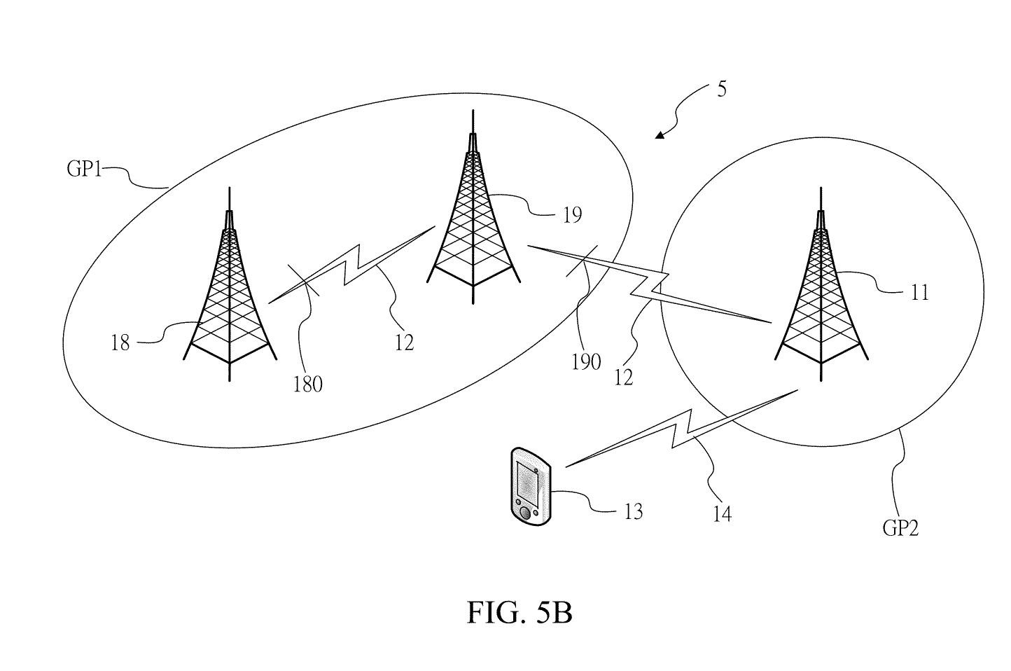

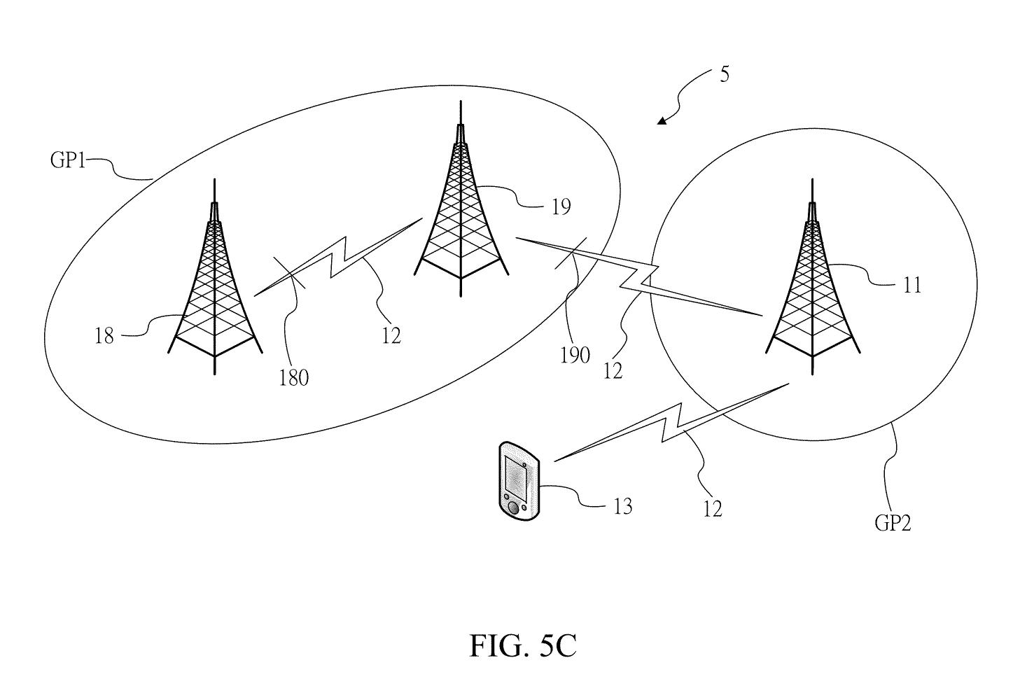

Please refer to FIGS. 5A˜5C, which show schematic views of an LAA network system 5 according to a fifth embodiment of the present invention. The data transmitting network device 11 is a first base station, the data receiving network device 13 is a mobile station, and the LAA network system 5 further comprises a second base station 19. The framework of the fifth embodiment is similar to those of the previous embodiments, so elements bearing the same symbols also have the same functions and will not be described again herein. The fifth embodiment will mainly describe the interference avoidance technology in more detail.

It shall be additionally noted that, in the fifth embodiment, the second base station 19 belongs to a first base station group GP1, the data transmitting network device 11 (i.e., the first base station) belongs to a second base station group GP2. The first base station group GP1 further comprises a third base station 18. The groups may be considered to be telecommunication operators. Therefore, as can be known from the conventional technologies, there is a protocol for coordinating the use of channels between base stations in a same group, and this will not be further described herein.

Firstly, before the unlicensed channel is used as described in the previous embodiments, a preliminary configuration is made according to the channel usage status of the nearby network devices. Specifically, in the fifth embodiment, the second base station 19 may firstly scan an unlicensed band (not depicted). The unlicensed band comprises the unlicensed channel 12.

Next, the second base station 19 receives a first message 180 of the third base station 18 in the unlicensed channel 12. Accordingly, the second base station 19 can determine that the unlicensed channel 12 is being used by the third base station 18 for data transmission. Then, the second base station 19 sends a second message 190 in the unlicensed channel 12 according to the first message 180 so as to notify other base stations that the unlicensed channel 12 is being used.

Thereby, when scanning the unlicensed band, the data transmitting network device 11 (i.e., the first base station) can receive the second message 190 in the unlicensed band 12 and learn therefrom that the unlicensed channel 12 is being used. Then, the data transmitting network device 11 (i.e., the first base station) may decide whether to choose the unlicensed channel 12 for data transmission with the data receiving network device 13 (i.e., the mobile station) according to the second message 190.

Please refer to FIG. 5B. For example, when the first message 180 and the second message 190 are physical layer signals, the data transmitting network device 11 (i.e., the first base station) can learn from the second message 190 that the unlicensed channel 12 is being used and, accordingly, choose another unlicensed channel 14 from the unlicensed band for data transmission with the data receiving network device 13 (i.e., the mobile station). Thus, the interferences can be directly avoided.

On the other hand, the first message 180 and the second message 190 may be system information block (SIB) messages, and comprise a piece of location information (not depicted) and a piece of channel usage information (not depicted) of the third base station 18. The channel usage information indicates that the unlicensed channel 12 is being used by the third base station 18. Then the data transmitting network device (i.e., the first base station) can directly learn from the second message 190 that the unlicensed channel 12 is being used by the third base station 18 and, accordingly, choose another unlicensed channel 14 from the unlicensed band for data transmission with the data receiving network device 13 (i.e., the mobile station).

However, it shall be particularly noted that, it is best for the data transmitting network device 11 (i.e., the first base station) not to use the unlicensed channel 12 for data transmission with the data receiving network device 13 (i.e., the mobile station) so as to mitigate the interferences possibly generated by the third base station 18 to the data receiving network device 13 (i.e., the mobile terminal). However, as the number of devices increases, the unlicensed channels will become short of supply, so it is still likely to choose an unlicensed channel that is already being used.

Please refer to FIG. 5C. If there is no idle unlicensed channel in the unlicensed band available for use, the data transmitting network device 11 (i.e., the first base station) can determine from the location information of the third base station 18 in the second message 190 that the distance from the data transmitting network device 11 to the third base station 18 exceeds a preset threshold value (a farther distance represents a lower possibility of interference occurrence).

Then, if the data transmitting network device 11 (i.e., the first base station) has a substantial distance from the third base station 18, it represents that the possibility of interference occurrence between the third base station 18 and the data transmitting network device 11 (i.e., the first base station) is relatively low. Therefore, the data transmitting network device 11 (i.e., the first base station) may choose the unlicensed channel 12 that is already being used by the third base station 18 for data transmission with the data receiving network device 13 (i.e., the mobile station). In cases where an unlicensed channel is repeatedly used, coordination may be made as described in the previous embodiments and will not be further described herein.

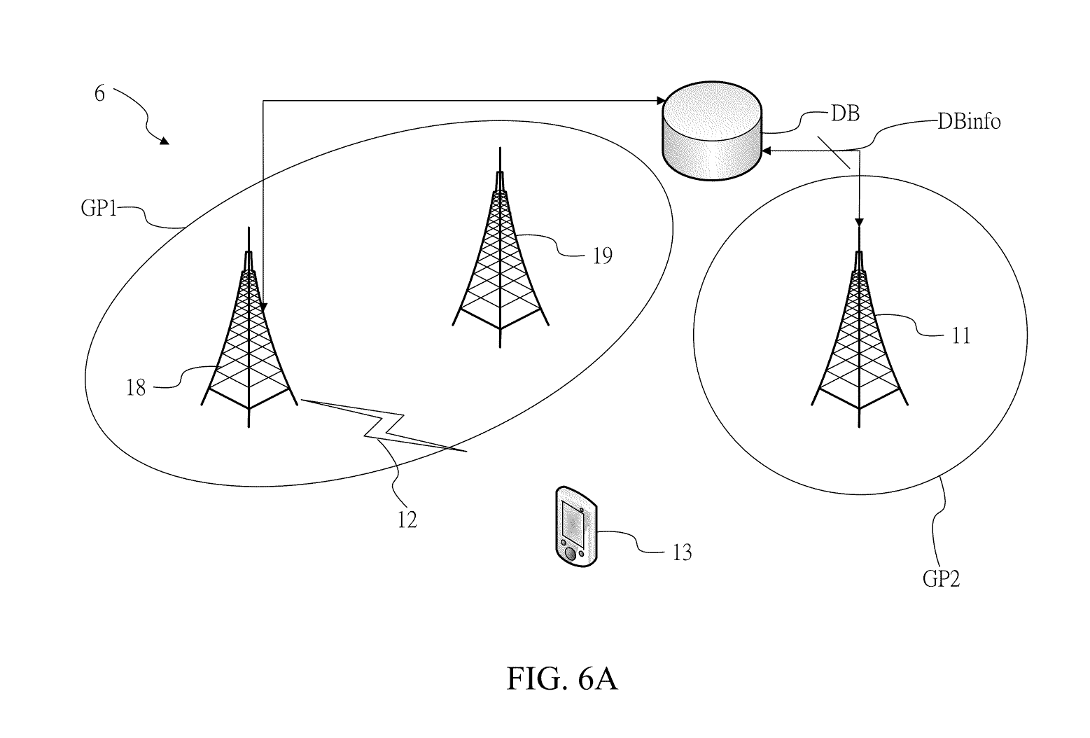

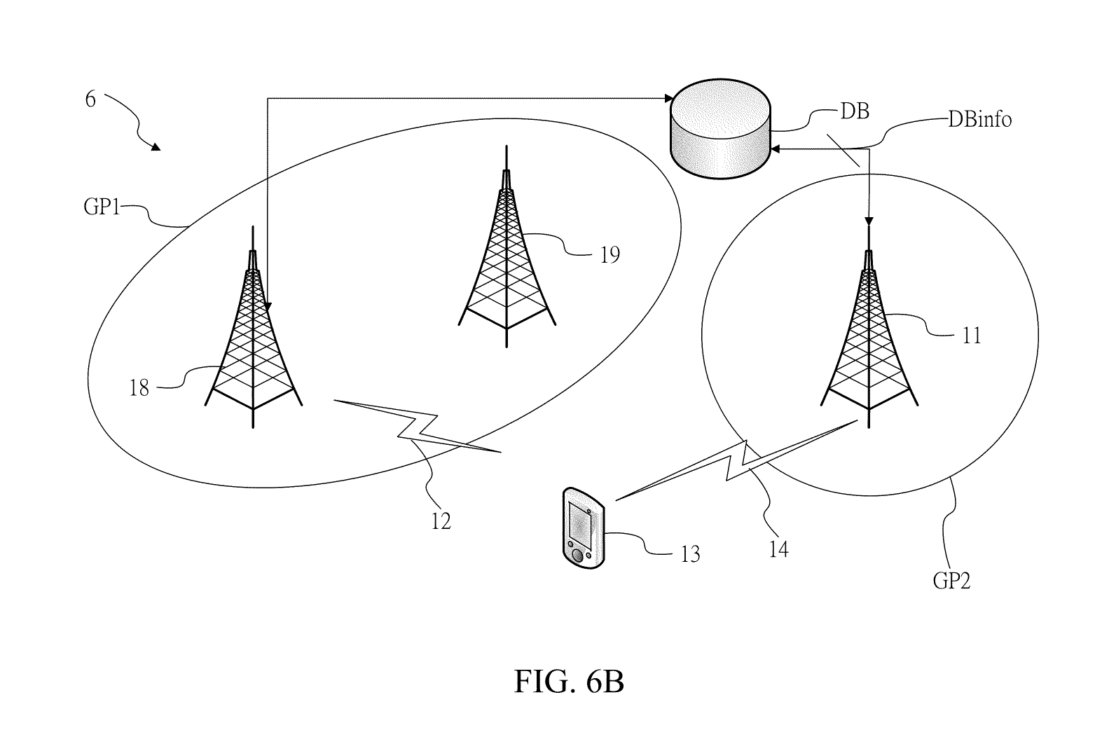

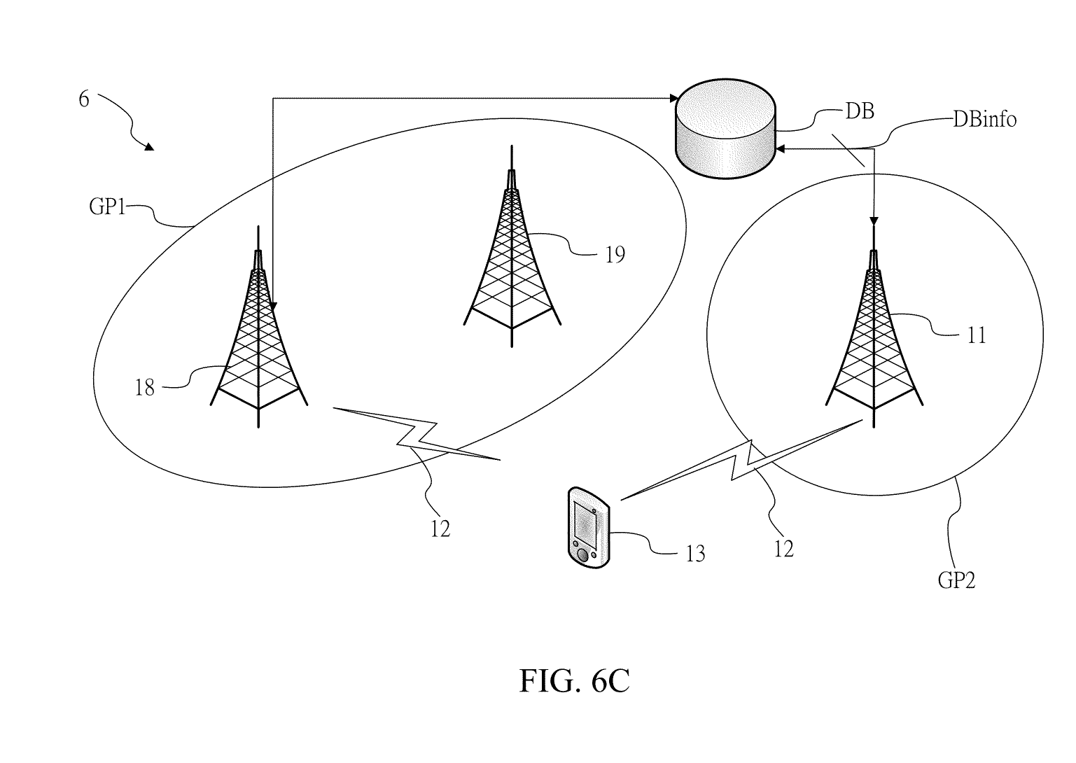

Please refer to FIGS. 6A˜6C, which are schematic views of an LAA network system 6 according to a sixth embodiment of the present invention. The framework of the sixth embodiment is similar to those of the previous embodiments, so elements bearing the same symbols also have the same functions and will not be described again herein. The sixth embodiment will mainly describe another implementation of the interference avoidance technology.

Similarly, before the unlicensed channel is used as described in the previous embodiments, a preliminary configuration is made according to the channel usage status of the nearby network devices. Specifically, in the sixth embodiment, the data transmitting network device 11 (i.e., the first base station) directly retrieves a piece of base station information DBinfo from a base station status database DB. The base station information DBinfo records the location information (not depicted) and the channel usage information (not depicted) of the third base station 18, and the channel usage information records that the unlicensed channel 12 is being used by the third base station 18 for data transmission.

Thereby, the data transmitting network device 11 (i.e., the first base station) can determine directly from the base station DBinfo that data transmission of the third base station 18 is already being performed in the unlicensed channel 12 and, accordingly, decide whether to choose the unlicensed channel 12 for data transmission with the data receiving network device 13 (i.e., the mobile station).

Please refer to FIG. 6B. For example, the data transmitting network device 11 (i.e., the first base station) can learn from the base station information DBinfo that the unlicensed channel 12 is being used by the third base station 18, so the data transmitting network device 11 (i.e., the first base station) may choose another unlicensed channel 14 from the unlicensed band for data transmission with the data receiving network device 13 (i.e., the mobile station) to directly avoid interferences.

Please refer to FIG. 6C. On the other hand, if there is no idle unlicensed channel available for use in the unlicensed band, the data transmitting network device 11 (i.e., the first base station) can determine from the location information of the third base station 18 in the base station information DBinfo that the distance from the data transmitting network device 11 to the third base station 18 exceeds a preset threshold value and, accordingly, the unlicensed channel 12 being used by the third base station 18 may be chosen for data transmission with the data receiving network device 13 (i.e., the mobile station). Similarly, in cases where an unlicensed channel is repeatedly used, coordination may be made as described in the previous embodiments and will not be further described herein.

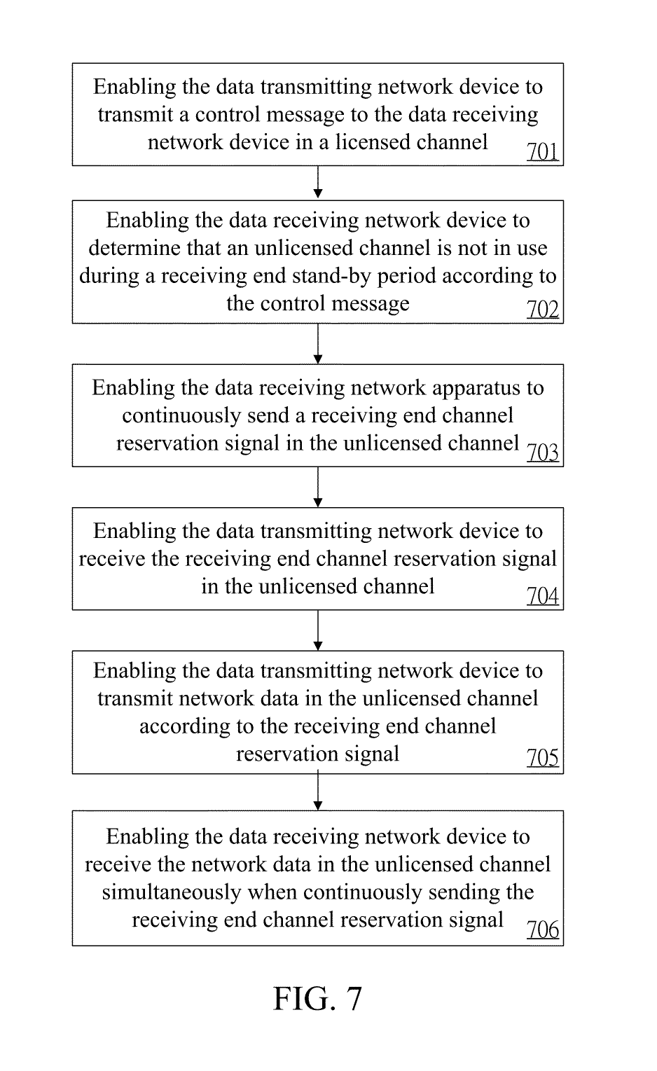

A seventh embodiment of the present invention is an interference avoidance method, a flowchart diagram of which is shown in FIG. 7. The method of the seventh embodiment is for use in an LAA network system (e.g., the LAA network system of one of the previous embodiments) comprising a data transmitting network device and a data receiving network device. Detailed steps of the seventh embodiment will be described hereinbelow.

Firstly, step 701 is executed to enable the data transmitting network device to transmit a control message to the data receiving network device in a licensed channel. Step 702 is executed to enable the data receiving network device to determine that an unlicensed channel is not in use during a receiving end stand-by period according to the control message. Step 703 is executed to enable the data receiving network apparatus to continuously send a receiving end channel reservation signal in the unlicensed channel according to the determination result of the step 702.

Then, step 704 is executed to enable the data transmitting network device to receive the receiving end channel reservation signal in the unlicensed channel. Step 705 is executed to enable the data transmitting network device to transmit network data in the unlicensed channel according to the receiving end channel reservation signal. Finally, step 706 is executed to enable the data receiving network device to receive the network data in the unlicensed channel simultaneously when continuously sending the receiving end channel reservation signal.

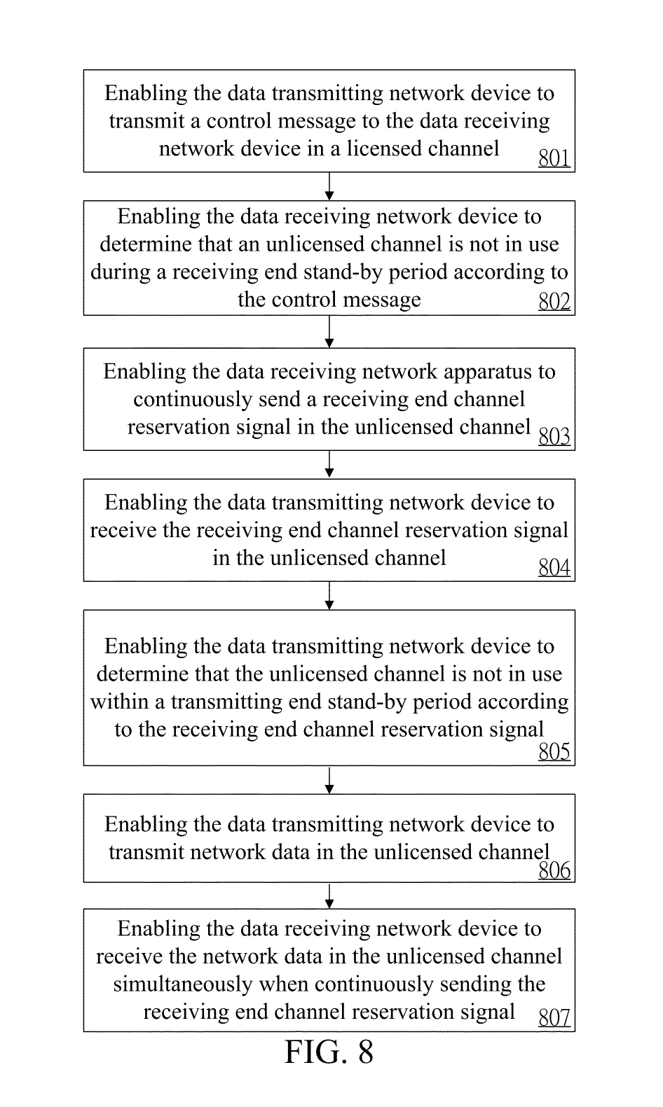

An eighth embodiment of the present invention is an interference avoidance method, a flowchart diagram of which is shown in FIG. 8. The method of the eighth embodiment is for use in an LAA network system (e.g., the LAA network system of one of the previous embodiments) comprising a data transmitting network device and a data receiving network device. Detailed steps of the eighth embodiment will be described hereinbelow.

Firstly, step 801 is executed to enable the data transmitting network device to transmit a control message to the data receiving network device in a licensed channel. Step 802 is executed to enable the data receiving network device to determine that an unlicensed channel is not in use during a receiving end stand-by period according to the control message. Step 803 is executed to enable the data receiving network apparatus to continuously send a receiving end channel reservation signal in the unlicensed channel according to the determination result of the step 802.

Then, step 804 is executed to enable the data transmitting network device to receive the receiving end channel reservation signal in the unlicensed channel. Step 805 is executed to enable the data transmitting network device to determine that the unlicensed channel is not in use within a transmitting end stand-by period according to the receiving end channel reservation signal. Step 806 is executed to enable the data transmitting network device to transmit network data in the unlicensed channel according to the determination result of the step 805. Finally, step 807 is executed to enable the data receiving network device to receive the network data in the unlicensed channel simultaneously when continuously sending the receiving end channel reservation signal.

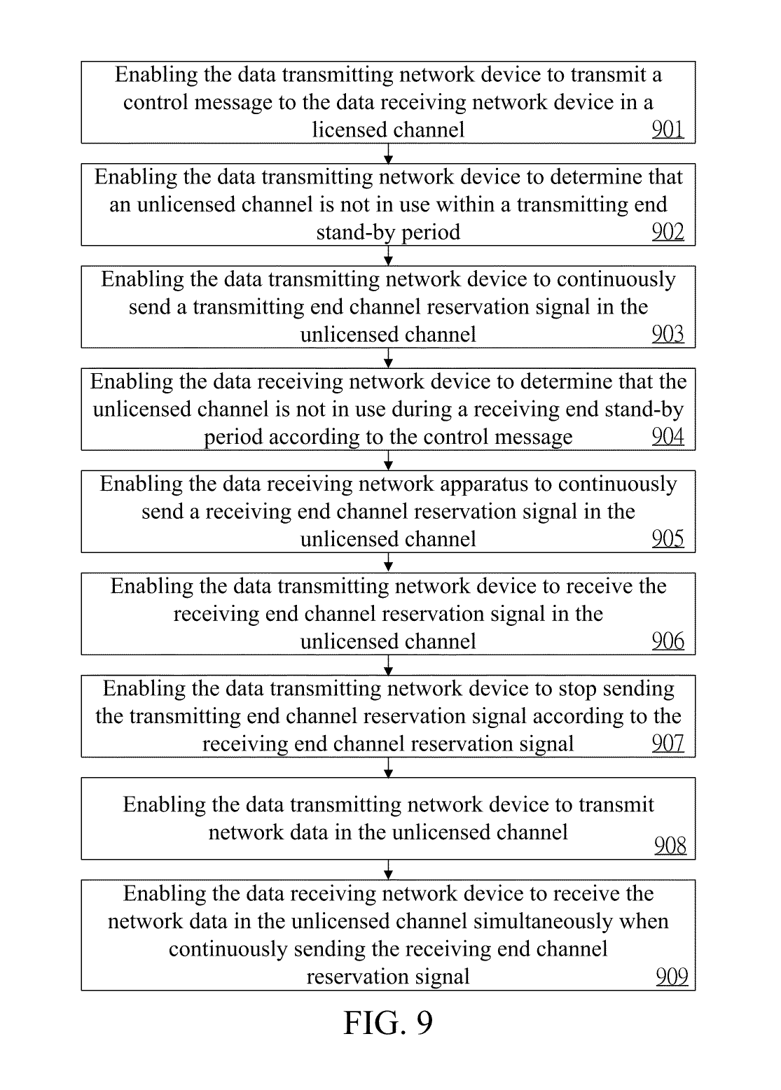

A ninth embodiment of the present invention is an interference avoidance method, a flowchart diagram of which is shown in FIG. 9. The method of the ninth embodiment is for use in an LAA network system (e.g., the LAA network system of one of the previous embodiments) comprising a data transmitting network device and a data receiving network device. Detailed steps of the ninth embodiment will be described hereinbelow.

Firstly, step 901 is executed to enable the data transmitting network device to transmit a control message to the data receiving network device in a licensed channel. Step 902 is executed to enable the data transmitting network device to determine that an unlicensed channel is not in use within a transmitting end stand-by period. Step 903 is executed to enable the data transmitting network device to continuously send a transmitting end channel reservation signal in the unlicensed channel according to the determination result of the step 902.

Step 904 is executed to enable the data receiving network device to determine that the unlicensed channel is not in use during a receiving end stand-by period according to the control message. Step 905 is executed to enable the data receiving network apparatus to continuously send a receiving end channel reservation signal in the unlicensed channel according to the determination result of the step 904.

Then, step 906 is executed to enable the data transmitting network device to receive the receiving end channel reservation signal in the unlicensed channel. Step 907 is executed to enable the data transmitting network device to stop sending the transmitting end channel reservation signal according to the receiving end channel reservation signal. Step 908 is executed to enable the data transmitting network device to transmit network data in the unlicensed channel after the step 907. Finally, step 909 is executed to enable the data receiving network device to receive the network data in the unlicensed channel simultaneously when continuously sending the receiving end channel reservation signal.

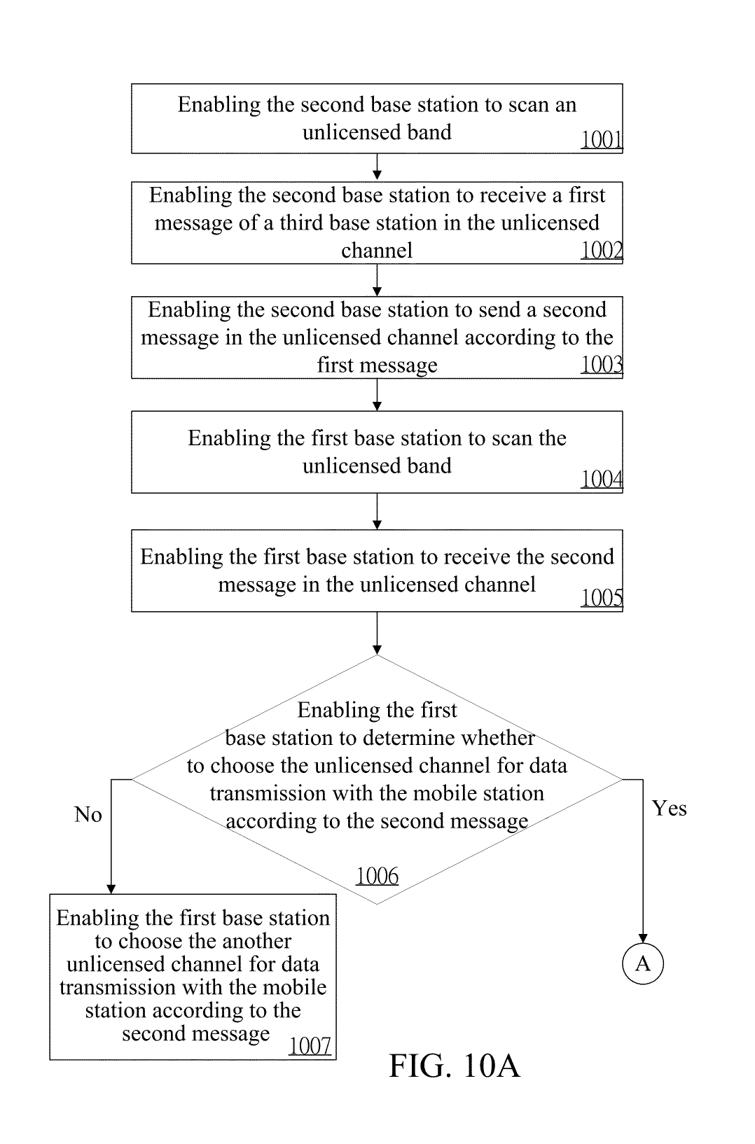

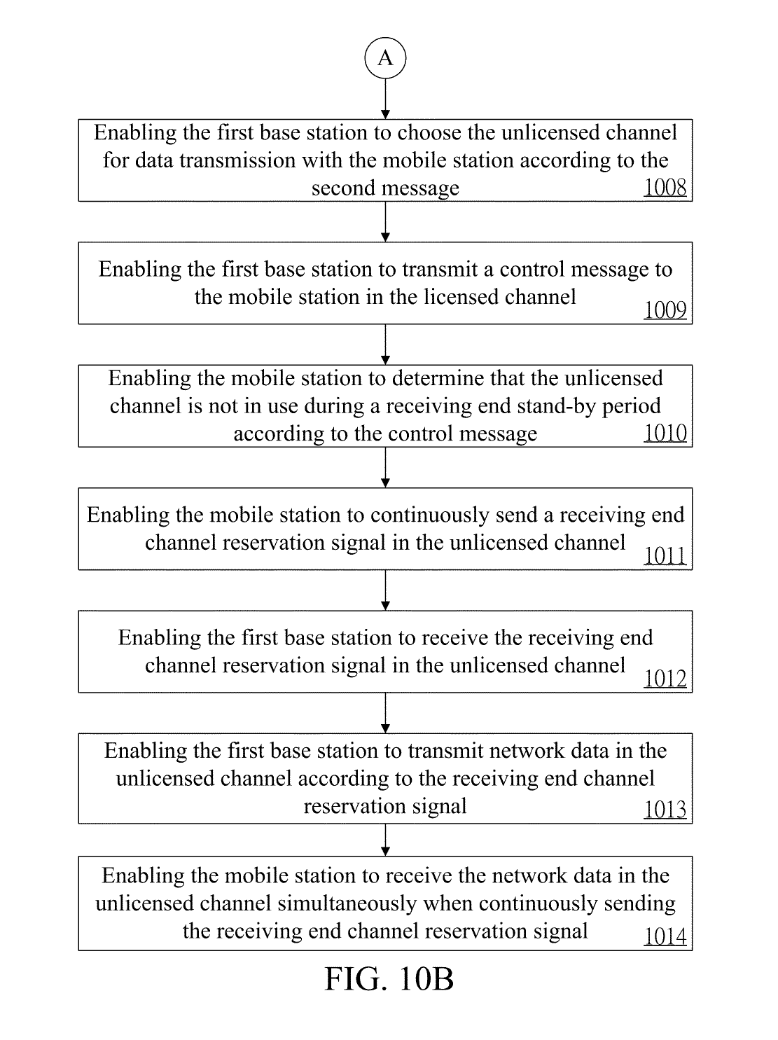

A tenth embodiment of the present invention is an interference avoidance method, a flowchart diagram of which is shown in FIG. 10. The method of the tenth embodiment is for use in an LAA network system (e.g., the LAA network system of one of the previous embodiments) comprising a first base station, a second base station and a mobile station. Detailed steps of the tenth embodiment will be described hereinbelow.

Firstly, step 1001 is executed to enable the second base station to scan an unlicensed band comprising the unlicensed channel. Step 1002 is executed to enable the second base station to receive a first message of a third base station in the unlicensed channel after the step 1001. Step 1003 is executed to enable the second base station to send a second message in the unlicensed channel according to the first message.

Then, step 1004 is executed to enable the first base station to scan the unlicensed band. Step 1005 is executed to enable the first base station to receive the second message in the unlicensed channel. Step 1006 is executed to enable the first base station to determine whether to choose the unlicensed channel for data transmission with the mobile station according to the second message.

Specifically, if the first base station determines that there is still another unlicensed channel unoccupied in the unlicensed band, then step 1007 is executed to enable the first base station to choose the another unlicensed channel for data transmission with the mobile station according to the second message. Conversely, if the first base station determines that there is no unoccupied unlicensed channel in the unlicensed band, then step 1008 is executed to enable the first base station to choose the unlicensed channel for data transmission with the mobile station according to the second message.

Next, step 1009 is executed to enable the first base station to transmit a control message to the mobile station in the licensed channel. Step 1010 is executed to enable the mobile station to determine that the unlicensed channel is not in use during a receiving end stand-by period according to the control message, and step 1011 is executed to enable the mobile station to continuously send a receiving end channel reservation signal in the unlicensed channel according to the determination result of the step 1010.

Afterwards, step 1012 is executed to enable the first base station to receive the receiving end channel reservation signal in the unlicensed channel. Step 1013 is executed to enable the first base station to transmit network data in the unlicensed channel according to the receiving end channel reservation signal. Finally, step 1014 is executed to enable the mobile station to receive the network data in the unlicensed channel simultaneously when continuously sending the receiving end channel reservation signal.

It shall be particularly noted that, as in the previous embodiments, the first message and the second message of the tenth embodiment may be physical layer signals or be SIB messages comprising the location information and the channel usage information of the base station, and the way of determining the usage status of the unlicensed channel according to the location information and the channel usage information of the base station is also the same as what described in the previous embodiments, so these will not be further described herein.

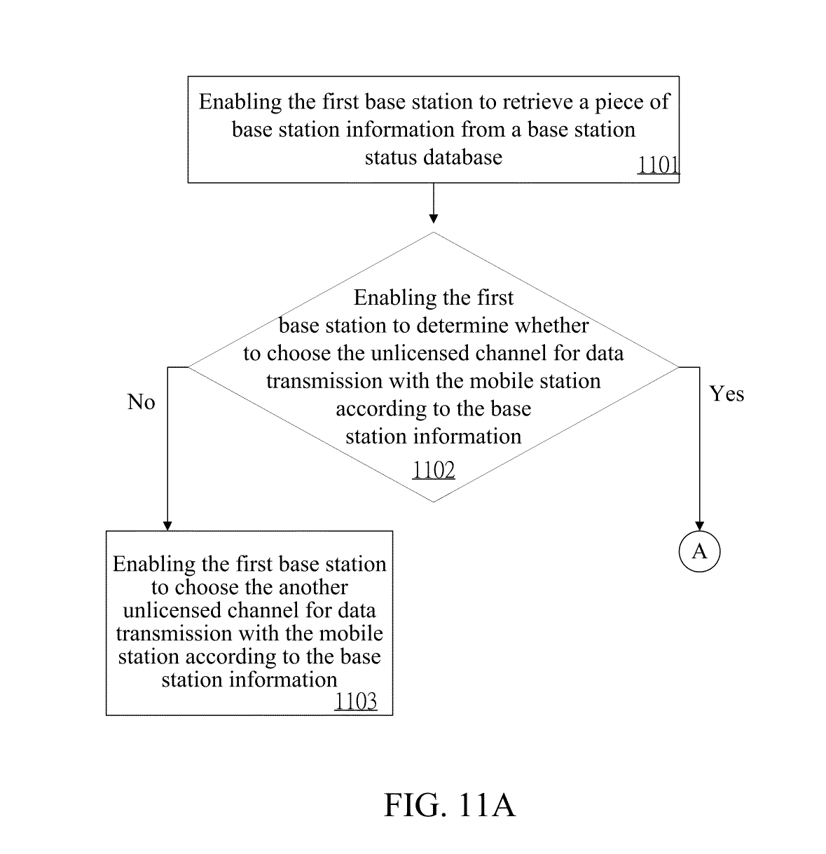

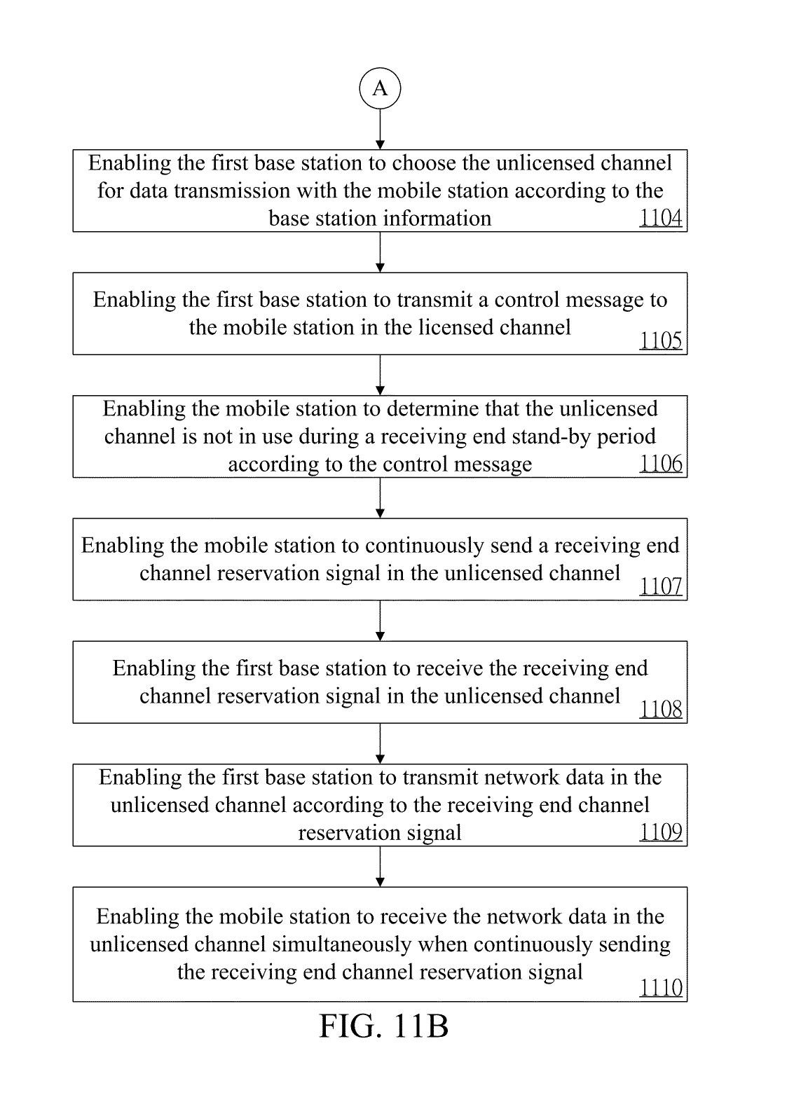

An eleventh embodiment of the present invention is an interference avoidance method, flowchart diagrams of which are shown in FIGS. 11A˜11B. The method of the eleventh embodiment is for use in an LAA network system (e.g., the LAA network system of one of the previous embodiments) comprising a first base station and a mobile station. Detailed steps of the eleventh embodiment will be described hereinbelow.

Firstly, step 1101 is executed to enable the first base station to retrieve a piece of base station information from a base station status database. Here, the base station information records a piece of location information and a piece of channel usage information of a second base station, and the channel usage information records that an unlicensed channel is used by the second base station for data transmission. Step 1102 is executed to enable the first base station to determine whether to choose the unlicensed channel for data transmission with the mobile station according to the base station information.

Similarly, if the first base station determines that there is still another unlicensed channel unoccupied in the unlicensed band, then step 1103 is executed to enable the first base station to choose the another unlicensed channel for data transmission with the mobile station according to the base station information. Conversely, if the first base station determines that there is no unoccupied unlicensed channel in the unlicensed band, then step 1104 is executed to enable the first base station to choose the unlicensed channel for data transmission with the mobile station according to the base station information.

Next, step 1105 is executed to enable the first base station to transmit a control message to the mobile station in the licensed channel. Step 1106 is executed to enable the mobile station to determine that the unlicensed channel is not in use during a receiving end stand-by period according to the control message, and step 1107 is executed to enable the mobile station to continuously send a receiving end channel reservation signal in the unlicensed channel according to the determination result of the step 1106.

Afterwards, step 1108 is executed to enable the first base station to receive the receiving end channel reservation signal in the unlicensed channel. Step 1109 is executed to enable the first base station to transmit network data in the unlicensed channel according to the receiving end channel reservation signal. Finally, step 1110 is executed to enable the mobile station to receive the network data in the unlicensed channel simultaneously when continuously sending the receiving end channel reservation signal.

Likewise, as in the previous embodiments, the base station information of the eleventh embodiment may comprise the location information and the channel usage information of the base station, and the way of determining the usage status of the unlicensed channel according to the location information and the channel usage information of the base station is also the same as what described in the previous embodiments, so these will not be further described herein.

According to the above descriptions, the main concept of the LAA network system and the interference avoidance method thereof according to the present invention is to firstly determine whether there is a possible unknown network device that is using a same unlicensed channel, and then according to the determination result, choose another unlicensed channel or make a reservation for the same unlicensed channel so as to avoid potential interferences that would occur subsequently. Thereby, an improvement can be made on the shortcoming of the conventional LAA technology through coordination between operations of different base stations in the unlicensed channels to greatly mitigate the communication interferences.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An interference avoidance method for a licensed assisted access (LAA) network system, the LAA network system comprising a data transmitting network device and a data receiving network device, the interference avoidance method comprising:
(a) the data transmitting network device transmitting a control message to the data receiving network device in a licensed channel;
(b) the data receiving network device determining that an unlicensed channel is not in use during a receiving end stand-by period according to the control message;
(c) the data receiving network apparatus continuously sending a receiving end channel reservation signal in the unlicensed channel according to the determination result of the step (b);
(d) the data transmitting network device receiving the receiving end channel reservation signal in the unlicensed channel;
(e) the data transmitting network device transmitting network data in the unlicensed channel according to the receiving end channel reservation signal; and
(f) the data receiving network device receiving the network data in the unlicensed channel simultaneously when continuously sending the receiving end channel reservation signal.

2. The interference avoidance method of claim 1, wherein the step (e) further comprising:
(e1) the data transmitting network device determining that the unlicensed channel is not in use during a transmitting end stand-by period according to the receiving end channel reservation signal; and
(e2) the data transmitting network device transmitting the network data in the unlicensed channel according to the determination result of the step (e1).

3. The interference avoidance method of claim 1, further comprising the following after the step (a):
(a1) the data transmitting network device determining that the unlicensed channel is not in use within a transmitting end stand-by period; and
(a2) the data transmitting network device continuously sending a transmitting end channel reservation signal in the unlicensed channel according to the determination result of the step (a1);
and wherein the step (e) further comprises:
(e1) the data transmitting network device stopping sending the transmitting end channel reservation signal according to the receiving end channel reservation signal; and
(e2) the data transmitting network device transmitting the network data in the unlicensed channel after the step (e1).

4. The interference avoidance method of claim 1, wherein the data transmitting network device is a first base station, the data receiving network device is a mobile station, and the LAA network system further comprises a second base station, the method further comprising the following steps before the step (a):
(a1) the second base station scanning an unlicensed band, wherein the unlicensed band comprises the unlicensed channel;
(a2) the second base station receiving a first message of a third base station in the unlicensed channel after step (a1);
(a3) the second base station sending a second message in the unlicensed channel according to the first message;
(a4) the first base station scanning the unlicensed band after the step (a3);
(a5) the first base station receiving the second message in the unlicensed channel; and
(a6) the first base station choosing the unlicensed channel for data transmission with the mobile station.

5. The interference avoidance method of claim 4, wherein the first message and the second message are physical layer signals.

6. The interference avoidance method of claim 4, wherein the first message and the second message are system information block (SIB) messages including a piece of location information and a piece of channel usage information of the third base station, and the step (a6) further comprising:
(a61) the first base station choosing the unlicensed channel for data transmission with the mobile station according to the location information and the channel usage information of the third base station.

7. The interference avoidance method of claim 1, wherein the data transmitting network device is a first base station, and the data receiving network device is a mobile station, the method further comprising the following steps before the step (a):
(a1) the first base station retrieving a piece of base station information from a base station status database, wherein the base station information records a piece of location information and a piece of channel usage information of a second base station, and the channel usage information records that the unlicensed channel is used by the second base station for data transmission; and
(a2) the first base station choosing the unlicensed channel for data transmission with the mobile station according to the base station information.

8. A licensed assisted access (LAA) network system, comprising:
a data transmitting network device; and
a data receiving network device;
wherein the data transmitting network device transmits a control message to the data receiving network device in a licensed channel, the data receiving network device determines that an unlicensed channel is not in use during a receiving end stand-by period according to the control message and continuously sends a receiving end channel reservation signal in the unlicensed channel, the data transmitting network device receives the receiving end channel reservation signal in the unlicensed channel and transmits network data in the unlicensed channel according to the receiving end channel reservation signal, and the data receiving network device receives the network data in the unlicensed channel simultaneously when continuously sending the receiving end channel reservation signal.

9. The LAA network system of claim 8, wherein the data transmitting network device determines that the unlicensed channel is not in use during a transmitting end stand-by period according to the receiving end channel reservation signal, and transmits the network data in the unlicensed channel.

10. The LAA network system of claim 8, wherein the data transmitting network device determines that the unlicensed channel is not in use within a transmitting end stand-by period and continuously sends a transmitting end channel reservation signal in the unlicensed channel, and the data transmitting network device stops sending the transmitting end channel reservation signal according to the receiving end channel reservation signal and transmits the network data in the unlicensed channel.

11. The LAA network system of claim 8, wherein the data transmitting network device is a first base station, the data receiving network device is a mobile station, and the LAA network system further comprises a second base station, the second base station scans an unlicensed band, wherein the unlicensed band comprises the unlicensed channel, the second base station receives a first message of a third base station in the unlicensed channel and sends a second message in the unlicensed channel according to the first message, the first base station scans the unlicensed band, receives the second message in the unlicensed channel, and chooses the unlicensed channel for data transmission with the mobile station according to the second message.

12. The LAA network system of claim 11, wherein the first message and the second message are physical layer signals.

13. The LAA network system of claim 11, wherein the first message and the second message are system information block (SIB) messages including a piece of location information and a piece of channel usage information of the third base station, and the first base station chooses the unlicensed channel for data transmission with the mobile station according to the location information and the channel usage information of the third base station.

14. The LAA network system of claim 8, wherein the data transmitting network device is a first base station, and the data receiving network device is a mobile station, the first base station retrieves a piece of base station information from a base station status database, wherein the base station information records a piece of location information and a piece of channel usage information of a second base station, and the channel usage information records that the unlicensed channel is used by the second base station for data transmission, and the first base station chooses the unlicensed channel for data transmission with the mobile station according to the base station information.

15. An interference avoidance method for a data transmitting network device, the data transmitting network device being used in an LAA network system, the LAA network system further comprising a data receiving network device, the interference avoidance method comprising:
(a) the data transmitting network device transmitting a control message to the data receiving network device in a licensed channel so that the data receiving network device determines that an unlicensed channel is not in use during a receiving end stand-by period according to the control message and continuously sends a receiving end channel reservation signal in the unlicensed channel;
(b) the data transmitting network device receiving the receiving end channel reservation signal in the unlicensed channel; and
(c) the data transmitting network device transmitting network data in the unlicensed channel according to the receiving end channel reservation signal so that the data receiving network device receives the network data in the unlicensed channel simultaneously when continuously sending the receiving end channel reservation signal.

16. The interference avoidance method of claim 15, wherein the step (c) further comprises:
(c1) the data transmitting network device determining that the unlicensed channel is not in use during a transmitting end stand-by period according to the receiving end channel reservation signal; and
(c2) the data transmitting network device transmitting the network data in the unlicensed channel according to the determination result of the step (c1) so that the data receiving network device receives the network data in the unlicensed channel simultaneously when continuously sending the receiving end channel reservation signal.

17. The interference avoidance method of claim 15, further comprising the following after step (a):
(a1) the data transmitting network device determining that the unlicensed channel is not in use within a transmitting end stand-by period; and
(a2) the data transmitting network device continuously sending a transmitting end channel reservation signal in the unlicensed channel according to the determination result of the step (a1);
and wherein the step (c) further comprises:
(c1) the data transmitting network device stopping sending the transmitting end channel reservation signal according to the receiving end channel reservation signal; and
(c2) the data transmitting network device transmitting the network data in the unlicensed channel after the step (c1) so that the data receiving network device receives the network data in the unlicensed channel simultaneously when continuously sending the receiving end channel reservation signal.

18. The interference avoidance method of claim 15, wherein the data transmitting network device is a first base station, the data receiving network device is a mobile station, the LAA network system further comprises a second base station, and the second base station scans an unlicensed band comprising the unlicensed channel, then receives a first message of a third base station in the unlicensed channel, and further sends a second message in the unlicensed channel according to the first message, the method further comprising the following before step (a):
(a1) the first base station scanning the unlicensed band;
(a2) the first base station receiving the second message in the unlicensed channel; and
(a3) the first base station to choosing the unlicensed channel for data transmission with the mobile station according to the second message.

19. The interference avoidance method of claim 18, wherein the first message and the second message are physical layer signals.

20. The interference avoidance method of claim 18, wherein the first message and the second message are system information block (SIB) messages including a piece of location information and a piece of channel usage information of the third base station, and the step (a3) further comprising:
(a31) the first base station choosing the unlicensed channel for data transmission with the mobile station according to the location information and the channel usage information of the third base station.

21. The interference avoidance method of claim 15, wherein the data transmitting network device is a first base station, and the data receiving network device is a mobile station, the method further comprising the following before the step (a):
(a1) the first base station retrieving a piece of base station information from a base station status database, wherein the base station information records a piece of location information and a piece of channel usage information of a second base station, and the channel usage information records that the unlicensed channel is used by the second base station for data transmission; and
(a2) the first base station choosing the unlicensed channel for data transmission with the mobile station according to the base station information.

22. A data transmitting network device for an LAA network system, the LAA network system further comprising a data receiving network device, the data transmitting network device comprising:
a processor; and
a transceiver;
wherein the processor transmits a control message via the transceiver to the data receiving network device in a licensed channel so that the data receiving network device determines that an unlicensed channel is not in use during a receiving end stand-by period according to the control message and continuously sends a receiving end channel reservation signal in the unlicensed channel, and the processor further receives the receiving end channel reservation signal in the unlicensed channel via the transceiver and transmits network data in the unlicensed channel so that the data receiving network device receives the network data in the unlicensed channel simultaneously when continuously sending the receiving end channel reservation signal.

23. The data transmitting network device of claim 22, wherein the processor further determines via the transceiver that the unlicensed channel is not in use during a transmitting end stand-by period according to the receiving end channel reservation signal, and transmits the network data in the unlicensed channel via the transceiver so that the data receiving network device receives the network data in the unlicensed channel simultaneously when continuously sending the receiving end channel reservation signal.

24. The data transmitting network device of claim 22, wherein the processor further determines via the transceiver that the unlicensed channel is not in use within a transmitting end stand-by period, and continuously sends a transmitting end channel reservation signal in the unlicensed channel, and the processor further stops sending the transmitting end channel reservation signal according to the receiving end channel reservation signal and via the transceiver, and transmits the network data in the unlicensed channel so that the data receiving network device receives the network data in the unlicensed channel simultaneously when continuously sending the receiving end channel reservation signal.

25. The data transmitting network device of claim 22, wherein the data transmitting network device is a first base station, the data receiving network device is a mobile station, the LAA network system further comprises a second base station, and the second base station scans an unlicensed band comprising the unlicensed channel, then receives a first message of a third base station in the unlicensed channel, and further sends a second message in the unlicensed channel, and the processor further scans the unlicensed band via the transceiver, receives the second message in the unlicensed channel via the transceiver, and chooses the unlicensed channel for data transmission with the mobile station according to the second message.

26. The data transmitting network device of claim 25, wherein the first message and the second message are physical layer signals.

27. The data transmitting network device of claim 25, wherein the first message and the second message are system information block (SIB) messages including a piece of location information and a piece of channel usage information of the third base station, and the processor chooses the unlicensed channel for data transmission with the mobile station according to the location information and the channel usage information of the third base station.

28. The data transmitting network device of claim 22, wherein the data transmitting network device is a first base station, and the data receiving network device is a mobile station, the processor retrieves a piece of base station information from a base station status database, the base station information records a piece of location information and a piece of channel usage information of a second base station, and the channel usage information records that the unlicensed channel is used by the second base station for data transmission, and the processor chooses the unlicensed channel according to the base station information for data transmission with the mobile station via the transceiver.

29. An interference avoidance method for a data receiving network device, the data receiving network device being used in an LAA network system, the LAA network system further comprising a data transmitting network device, the interference avoidance method comprising:
(a) the data receiving network device receiving a control message from the data transmitting network device in a licensed channel;
(b) the data receiving network device determining that an unlicensed channel is not in use during a receiving end stand-by period according to the control message;
(c) the data receiving network apparatus continuously sending a receiving end channel reservation signal in the unlicensed channel according to the determination result of step (b) so that the data transmitting network device receives the receiving end channel reservation signal in the unlicensed channel and transmits network data in the unlicensed channel according to the receiving end channel reservation signal; and
(d) the data receiving network device receiving the network data in the unlicensed channel simultaneously when continuously sending the receiving end channel reservation signal.

30. A data receiving network device for an LAA network system, the LAA network system further comprising a data transmitting network device, the data receiving network device comprising:
a processor; and
a transceiver;
wherein the processor receives a control message from the data transmitting network device in a licensed channel, determines via the transceiver that an unlicensed channel is not in use during a receiving end stand-by period according to the control message and continuously sends a receiving end channel reservation signal in the unlicensed channel so that the data transmitting network device receives the receiving end channel reservation signal in the unlicensed channel and transmits network data in the unlicensed channel according to the receiving end channel reservation signal; and the processor receives the network data in the unlicensed channel via the transceiver simultaneously when continuously sending the receiving end channel reservation signal.
